(19) United States
(12) Patent Application Publication
(10) Pub. No.: US 2025/0254359 A1
(43) Pub. Date: Aug. 7, 2025

(54) METHOD, APPARATUS, AND MEDIUM FOR POINT CLOUD CODING

(71) Applicants: Beijing Bytedance Network Technology Co., Ltd., Beijing (CN); Bytedance Inc., Los Angeles, CA (US)

(72) Inventors: Wenyi WANG, Beijing (CN); Yingzhan XU, Beijing (CN); Kai ZHANG, Los Angeles, CA (US); Li ZHANG, Los Angeles, CA (US)

(21) Appl. No.: 19/183,664

(22) Filed: Apr. 18, 2025

Related U.S. Application Data
(63) Continuation of application No. PCT/CN2023/125456, filed on Oct. 19, 2023.

(30) Foreign Application Priority Data
Oct. 20, 2022 (WO) PCT/CN2022/126532

(51) Int. Cl. H04N 19/597; H04N 19/13; H04N 19/167; H04N 19/169

(52) U.S. Cl. CPC H04N 19/597; H04N 19/13; H04N 19/167; H04N 19/1883

(57) ABSTRACT

Embodiments of the present disclosure provide a solution for point cloud coding. A method for point cloud coding is proposed. The method comprises: determining, during a conversion between a current frame of a point cloud sequence and a bitstream of the point cloud sequence, a plurality of azimuthal angle metric values of a plurality of key points associated with a node of the current frame, the node representing a spatial partition of the current frame; determining a prediction of azimuthal angle metric value of the node; determining a context of entropy coding for a plane position of at least one axis associated with the node based on the plurality of azimuthal angle metric values and the prediction of azimuthal angle metric value; and performing the conversion based on the context of entropy coding.

### CROSS REFERENCE TO RELATED APPLICATIONS

This application is a continuation of International Application No. PCT/CN2023/125456, filed on Oct. 19, 2023, which claims the benefit of International Application No. PCT/CN2022/126532 filed on Oct. 20, 2022. The entire contents of these applications are hereby incorporated by reference in their entireties.

### FIELD

Embodiments of the present disclosure relates generally to video coding techniques, and more particularly, to entropy coding of plane information for point cloud coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, during a conversion between a current frame of a point cloud sequence and a bitstream of the point cloud sequence, a plurality of azimuthal angle metric values of a plurality of key points associated with a node of the current frame, the node representing a spatial partition of the current frame; determining a prediction of azimuthal angle metric value of the node; determining a context of entropy coding for a plane position of at least one axis associated with the node based on the plurality of azimuthal angle metric values and the prediction of azimuthal angle metric value; and performing the conversion based on the context of entropy coding. The method in accordance with the first aspect of the present disclosure determines the context of entropy coding for the plane position of at least one axis based on azimuthal angles of several key points and a predicted azimuthal angle, and thus can improve the efficiency of point cloud coding.

In a second aspect, an apparatus for processing point cloud sequence is proposed. The apparatus for processing point cloud sequence comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, a non-transitory computer-readable recording medium is proposed. The non-transitory computer-readable recording medium stores a bitstream of a point cloud sequence which is generated by a method performed by a point cloud sequence processing apparatus. The method comprises: determining a plurality of azimuthal angle metric values of a plurality of key points associated with a node of a current frame of the point cloud sequence, the node representing a spatial partition of the current frame; determining a prediction of azimuthal angle metric value of the node; determining a context of entropy coding for a plane position of at least one axis associated with the node based on the plurality of azimuthal angle metric values and the prediction of azimuthal angle metric value; and generating the bitstream based on the context of entropy coding.

In a fifth aspect, a method for storing a bitstream of a point cloud sequence is proposed. The method comprises: determining a plurality of azimuthal angle metric values of a plurality of key points associated with a node of a current frame of the point cloud sequence, the node representing a spatial partition of the current frame; determining a prediction of azimuthal angle metric value of the node; determining a context of entropy coding for a plane position of at least one axis associated with the node based on the plurality of azimuthal angle metric values and the prediction of azimuthal angle metric value; generating the bitstream based on the context of entropy coding; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example point cloud coding system, in accordance with some embodiments of the present disclosure;

FIG. 2 illustrates a block diagram that illustrates an example of a GPCC encoder, in accordance with some embodiments of the present disclosure;

FIG. 3 illustrates a block diagram that illustrates an example of a GPCC decoder, in accordance with some embodiments of the present disclosure;

FIG. 4 illustrates an example of the coding flow for the improvement of point cloud geometry coding using LIDAR characteristics;

FIG. 5 illustrates a flowchart of a method for point cloud coding in accordance with some embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

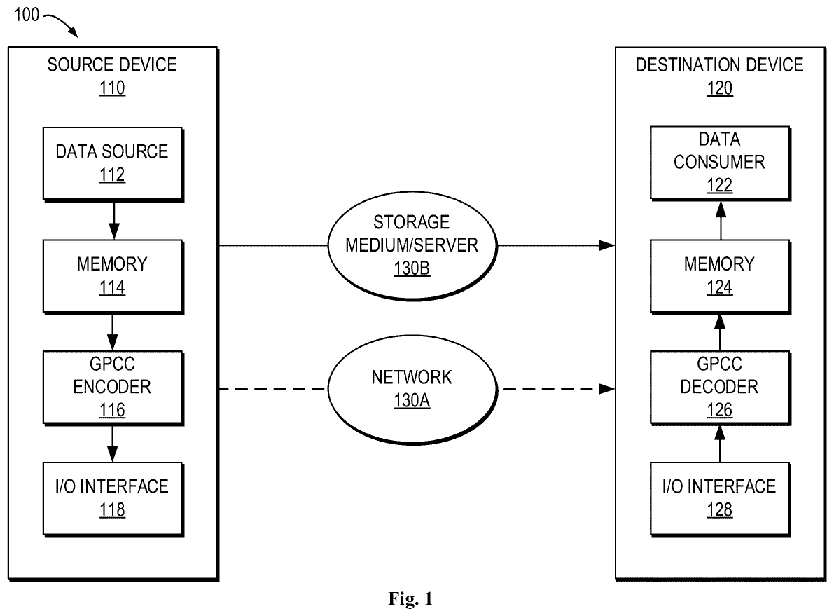

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

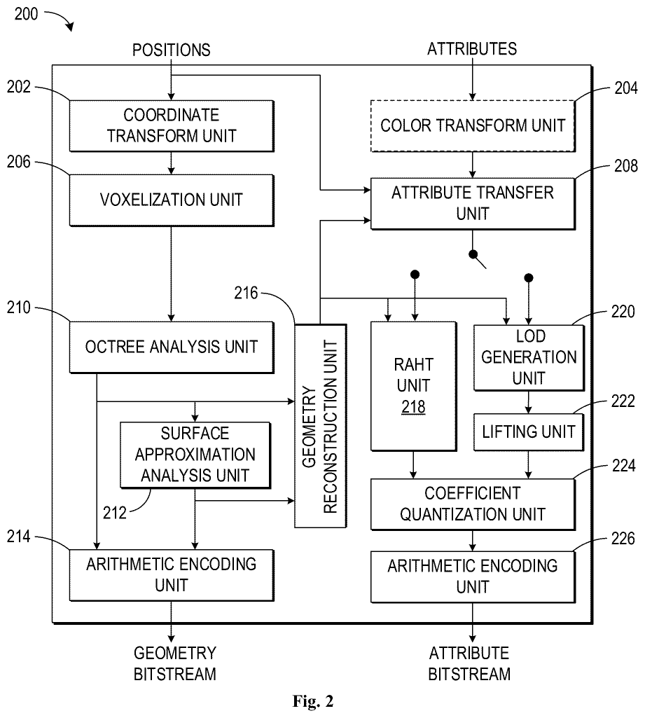

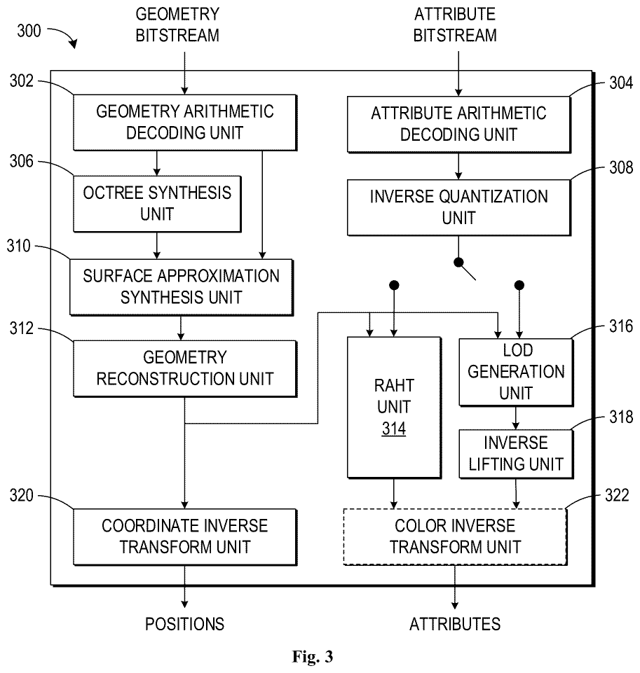

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. BRIEF SUMMARY

This disclosure is related to point cloud coding technologies. Specifically, it is related to point cloud geometry coding using LIDAR characteristics. The ideas may be applied individually or in various combination, to any point cloud coding standard or non-standard point cloud codec, e.g., the being-developed Geometry based Point Cloud Compression (G-PCC).

### 2. ABBREVIATIONS

G-PCC Geometry based Point Cloud Compression
MPEG Moving Picture Experts Group
3DG 3D Graphics Coding Group
CFP Call For Proposal
V-PCC Video-based Point Cloud Compression
DCM Direct Coding Mode
IDCM Inferred Direct Coding Mode

### 3. INTRODUCTION

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on. One of the important applications of point cloud is automatic drive. In automatic drive, point cloud data mainly is captured by LIDAR. So some important characteristics of LIDAR can be leveraged to compress point cloud. For example, for standard spindle-type LIDAR, they always consist of multiple laser diodes aligned vertically, resulting an effective vertical (elevation) field of view. Then the entire unit can spin alone with its vertical axis at fixed speed to provide a full 360 degree azimuthal field of view.

The elevation angle and azimuthal angle of laser beam can be leveraged to compress point cloud geometry information.

Point cloud codec can process the various information in different ways. Usually there are many optional tools in the codec to support the coding and decoding of geometry information and attribute information respectively. Among geometry coding tools in G-PCC, the following tools have an important influence for point cloud geometry coding performance.

### 3.1 Octree Geometry Compression

In G-PCC, one of important point cloud geometry coding tools is octree geometry compression, which leverages point cloud geometry spatial correlation. If geometry coding tools is enabled, a cubical axis-aligned bounding box, associated with octree root node, will be determined according to point cloud geometry information. Then the bounding box will be subdivided into 8 sub-cubes, which are associated with 8 child node of root node (a cube is equivalent to node hereafter). An 8-bit code is then generated by specific order to indicate whether the 8 sub-nodes contain points separately, where one bit is associated with one node. The 8-bit code is named occupancy code and will be signaled according to the occupancy information of neighbor node. Only the nodes which contain points will be subdivided into 8 sub-nodes furtherly. The process will be performed recursively until the node size is 1. So, the point cloud geometry information is converted into occupancy code sequences.

In decoder side, occupancy code sequences will be decoded and the point cloud geometry information can be reconstructed according to the occupancy code sequences.

### 3.2 Planar Mode

Planar mode is a tool to improve occupancy code of octree node more efficiently. Before coding occupancy code of a node, the node will be judged whether it is eligible for planar mode or not according to specific eligibility condition in three dimensions separately.

Take the z axis as am example. If it is eligible for planar mode in z axis, a binary flag zIsPlanar is coded to signal whether its occupied child nodes belong to a same horizontal plane or not. If zIsPlaner is true, then an extra bit zPlanePosition is signaled if this plane is the lower plane or the upper plane, and the empty plane occupancy code can be ignored. Otherwise the node will continue normal tree coding process. The eligibility is based on tracking the probability of past coded node being planar as follows.
A node is eligible if and only if pₚₗₐₙₐᵣ≥T and d_{local}>3, where T is a user-defined probability threshold and d_{local} is local density which can derived according to neighbor node information.
Updating the probability pₚₗₐₙₐᵣ when a node occupancy is (de) coded or/and a node planar information is (de)coded as follows

$${p}_{planar} = ( L \times {p}_{planar} + δ ) / ( L + 1 )$$

where L=255 and δ is 1 if the coded node is planar and 0 otherwise.

The flag zIsPlaner is coded by using a binary arithmetic coder with the 3 contexts based on the axis information. If zIsPlaner is true, the zPlanePosition is coded by using a binary arithmetic coder.

### 3.3 Inferred Direct Coding Mode (IDCM)

The octree representation, or more generally any tree representation, is efficient at representing points with a spatial correlation because trees tend to factorize the higher order bits of the point coordinates. For an octree, each level of depth refines the coordinates of points within a sub-node by one bit for each component at a cost of eight bits per refinement. Further compression is obtained by entropy coding the split information associated with each tree node. However, if one node of octree contains isolated point, directly coding their relative coordinates in the node is better than octree representation. Because there are no other points in the node, no spatial correlation can be used. Directly coding point coordinates in a node/sub-node is called Direct Coding Mode (DCM). On the other hand, time complexity will be reduced using DCM because the octree recursive split process cannot be performed.

In G-PCC, every node will be judged whether it is eligible for DCM or not according to specific eligibility condition, which is called Inferred Direct Coding Mode (IDCM). If a node is eligible for DCM, a binary flag is coded to signal if the DCM is applied (flag=1) or not (flag=0) to the node. If the flag is equal to 1, then points belonging to the associated volume are directly coded using the DCM. Otherwise (the flag is equal to 0), the tree coding process continues for the current node.

Currently, there are two eligibility conditions for IDCM.
parent-based-eligibility. There is only one occupied child (=the current node) at parent-node level, AND the grand-parent node has at most two occupied children (=the parent node+possibly one other node).
6N eligibility. There is only one occupied child (=the current node) at parent-node level, AND there is no occupied neighbour N (among the six neighbours sharing a face with the current cube associated with the current node).

### 3.4 Angular Mode

In G-PCC, angular mode is introduced to improve the compression of isolated point relative coordinate in IDCM and plane position in planar. It just can be used to real time LIDAR capturing point cloud data. For standard spindle-type LIDAR, each laser has a fixed elevation angle and captures fixed max number points per spin. The angular mode uses the prior fixed elevation angle of each laser. It uses the child node elevation distance from laser elevation angle to improve compression of binary occupancy coding through the prediction of the plane position of the planar mode and the prediction of z-coordinate bits in DCM nodes.

The angular mode is applied for nodes which is fulfilled with elevation eligibility, i.e., if the elevation size is lower than the smallest the elevation delta between two adjacent lasers. If the node is eligible, it is only passed by one laser in elevation direction. Then laser passing the node elevation angle will be found and several key points elevation angle of the node will be calculated. According to the relation of the several key points elevation angle and laser passing the node elevation angle, contexts will be determined to help code the z-coordinate bits in DCM and the plane position of z axis in planar mode.

### 3.5 Azimuthal Mode

Similar with angular mode, azimuthal mode is introduced to improve the compression of isolated point relative coordinate in IDCM and plane position in planar. It just can be used to real time LIDAR capturing point cloud data, too. The azimuthal mode uses the prior information that each laser captures fixed max number points per spin. It uses azimuthal angle of already coded nodes to improve compression of binary occupancy coding through the prediction of the x or y plane position of the planar mode and the prediction of x or y-coordinate bits in DCM nodes. In current G-PCC, if a node is eligible for angular mode, it is eligible for azimuthal mode. If the node is eligible for azimuthal mode, the index of laser passing the node will be found. A prediction azimuthal angle will be determined according to the laser information and the azimuthal angle of an already coded node which has the same laser as the current node. Then several key points azimuthal angles of the node will be calculated. According to the position relation of the several key points azimuthal angles and prediction azimuthal angle, contexts will be determined to help code x-coordinate or y-coordinate bits in DCM and code the plane position of x or y axis in planar mode.

### 4. PROBLEMS

The existing designs for point cloud geometry coding have the following problems:
1. In current G-PCC, the occupancy information of parent-based node and the neighbor nodes are used for IDCM eligibility condition. In other words, whether the points in the current node are isolated points is only derived from the occupancy information of the parent node or the neighbor nodes. However, for LIDAR capturing point cloud data, there are some prior information which can be used for isolated point judgement. For example, if one node is passed by only one laser beam, it most likely contains only one point which means that the point is most likely an isolated point.
2. In current G-PCC, one node is eligible for azimuthal mode if and only if it is eligible for angular mode. However, the eligibility condition for angle mode can only ensure that it is passed by only one laser beam in the elevation direction. It is not clear whether the node is passed by only one laser beam in the azimuthal direction. Thus, the eligibility condition in azimuthal direction should be considered.

### 5. DETAILED DESCRIPTION

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.
1) For one node, the capturing laser by which the node is captured may be determined.
   a. In one example, the capturing laser of current node may be determined according to at least one representative node position and/or at least one laser elevation angle.
      i. In one example, the elevation angle of the node may be computed according to the node position.
      ii. In one example, the laser which has the nearest elevation angle with elevation angle of the node may be regarded as the capturing laser.
      iii. Alternatively, the laser with the minimum elevation angle among lasers whose elevation angles are greater than elevation angle of the node may be regarded as the capturing laser.
      iv. Alternatively, the laser with the maximum elevation angle among lasers whose elevation angles are less than elevation angle of the node may be regarded as the capturing laser.
      v. In one example, a predefined point position of the node may be used to as the representative position of the node, such as midpoint position, vertex position, original point position and so on.
         1. Alternatively, the representative position may be signaled from an encoder to a decoder.
      vi. In one example, a function value of elevation angle of the node may be used to represent its elevation angle.
         1. The function may be tangent, cotangent, sine, cosine and so on.
      vii. In one example, a function value of elevation angle of one laser may be used to represent its elevation angle.
         1. The function may be tangent, cotangent, sine, cosine and so on.
   b. Alternatively, the capturing laser of current node may be determined according to the capturing laser of other nodes.
      i. In one example, the capturing laser of current node may be the capturing laser of its parent node.
   c. Alternatively, furthermore, the capturing laser of current node may be used for determining whether a node is passed only by one laser beam in elevation direction or azimuthal direction.
2) Whether a node is restricted to be passed only by one laser beam in elevation direction or not is determined in the encoding/decoding process.
   a. In one example, whether the node is passed only by one laser beam in elevation direction or not may depend on the relation between the elevation angle size covered by the node and the valid elevation angle scanning size of its capturing laser.
      i. In one example, if the elevation angle size covered by the node is less than the valid elevation angle scanning size of its capturing laser, the node may be regarded to be passed only by one laser beam in elevation direction.
      ii. Alternatively, if the elevation angle size covered by the node is less than or equal to the valid elevation angle scanning size of its capturing laser, the node may be regarded to be passed only by one laser beam in elevation direction.
   b. In one example, the valid elevation angle scanning size of its capturing laser may be equal to the minimum absolute value of all adjacent lasers elevation angle differences.
   c. Alternatively, the valid elevation angle scanning size of its capturing laser may be equal to the half of absolute value of its capturing laser's two adjacent lasers elevation angle differences.
   d. In one example, the elevation angle size covered by the node may be determined by at least one key point's elevation angle of the node.
      i. In one example, a predefined point position of the node may be used to as the key point position of the node, such as midpoint position, vertex position, original point position and so on.
         1. Alternatively, the key point position may be signaled from an encoder to a decoder.
      ii. In one example, the elevation angle size covered by the node may be equal to the absolute value of the difference in elevation angle between midpoint of upper surface and midpoint of lower surface of the node alone z axis.
      iii. Alternatively, the elevation angle size covered by the node may be equal to the absolute value of the difference between maximum elevation angle and minimum elevation angle of eight vertices of the node.
      iv. In one example, a function value of elevation angle of one point may be used to represent its elevation angle.
         1. The function may be tangent, cotangent, sine, cosine and so on.
      v. In one example, a function value of elevation angle of one laser may be used to represent its elevation angle.
         1. The function may be tangent, cotangent, sine, cosine and so on.
   e. In one example, the elevation angle size covered by the node may be replaced by the length of specific line segment covered by the node.
      i. In one example, the specific line segment may be the line segment between midpoint of upper surface and midpoint of lower surface of the node alone z axis.
   f. In one example, the valid elevation angle scanning size of the node capturing laser may be replaced by the length of specific line segment covered by the valid elevation angle scanning range of its capturing laser.
      i. In one example, the specific line segment may be the line segment that passes through the midpoint of the node and is parallel to the line segment between midpoint of upper surface and midpoint of lower surface of the node alone z axis.
3) Whether a node is restricted to be passed only by one laser beam in azimuthal direction or not is determined in the encoding/decoding process.
   a. In one example, whether the node is passed only by one laser beam in azimuthal direction or not may depend on the relation between the azimuthal angle size covered by the node and the valid azimuthal angle scanning size of its capturing laser beam.
      i. In one example, if the azimuthal angle size covered by the node is less than the valid azimuthal angle scanning size of its capturing laser beam, the node may be regarded to be passed only by one laser beam in azimuthal direction.
      ii. Alternatively, if the azimuthal angle size covered by the node is less than or equal to the valid azimuthal angle scanning size of its capturing laser beam, the node may be regarded to be passed only by one laser beam in azimuthal direction.
   b. In one example, the valid azimuthal angle scanning size of its capturing laser beam may be determined by the scanning parameters of its capturing laser.
      i. In one example, the valid azimuthal angle scanning size of its capturing laser beam may be determined by the scanning range and frequency of its capturing laser.
   c. In one example, the azimuthal angle size covered by the node may be determined by at least one key point's azimuthal angle of the node.
      i. In one example, a predefined point position of the node may be used to as the key point position of the node, such as midpoint position, vertex position, original point position and so on.
         1. Alternatively, the key point position may be signaled from an encoder to a decoder.
      ii. In one example, the azimuthal angle size covered by the node may be equal to the absolute value of the difference in azimuthal angle between midpoint of upper surface and midpoint of lower surface of the node alone x axis or y axis.
      iii. Alternatively, the azimuthal angle size covered by the node may be equal to the absolute value of the difference between maximum azimuthal angle and minimum azimuthal angle of eight vertices of the node.
   d. In one example, the azimuthal angle size covered by the node may be replaced by the length of specific line segment covered by the node.
      i. In one example, the specific line segment may be the line segment between midpoint of upper surface and midpoint of lower surface of the node alone x axis or y axis.
   e. In one example, the valid azimuthal angle scanning size of the node capturing laser beam may be replaced by the length of specific line segment covered by the valid azimuthal angle scanning range of its capturing laser beam.
      i. In one example, the specific line segment may be the line segment that passes through the midpoint of the node and is parallel to the line segment between midpoint of upper surface and midpoint of lower surface of the node alone x axis or y axis.
4) If a node is passed only by one laser beam in the encoding/decoding process, a certain coding mode may be applied.
   a. In one example, the node may be signaled by DCM if it is passed only by one laser beam.
   b. In one example, one node may be regarded to be passed only by one laser beam if it is passed only by one laser in elevation direction.
   c. Alternatively, one node may be regarded to be passed only by one laser beam if it is passed only by one laser beam in azimuthal direction.
   d. Alternatively, one node may be regarded to be passed only by one laser beam if it is passed only by one laser beam in elevation direction and azimuthal direction.
   e. In one example, the condition that the node is passed only by one laser beam may be the unique condition for the certain coding mode.
   f. Alternatively, the condition that the node is passed only by one laser beam may be combined with other conditions for the certain coding mode.
5) An indicator (e.g., being binary values) may be signaled to indicate whether the angular information is used for the eligibility condition of a certain coding mode or not.
   a. In one example, if the value of the indicator is equal to X (e.g., X=1), the angular information will be used for eligibility condition of a certain coding mode. Otherwise (if it is equal to (1-X)), the angular information will not be used for eligibility condition of a certain coding mode.
   b. In one example, the certain coding mode may be DCM.
   c. In one example, the indication may be coded with fixed-length coding, unary coding, truncated unary coding, etc. al.
   d. In one example, the indication may be coded in a predictive way.
6) The line density may be used to help determine whether the angular information is used for eligibility condition of a certain coding mode or not.
   a. In one example, the line density may be equal to the average points number alone one laser beam.
   b. Alternatively, the line density may be equal to the maximum points number alone one laser beam.
   c. In one example, the angular information is used for eligibility condition of a certain coding mode only if the line density is less than a density threshold.
   d. Alternatively, the angular information is used for eligibility condition of a certain coding mode only if the line density is less than or equal to a density threshold.
   e. In one example, the certain coding mode may be DCM.
   f. In one example, the line density may be used to derive the value of indicator that indicate whether the angular information is used for the eligibility condition of a certain coding mode or not.
7) The context of entropy coding for the plane position of at least one axis may be determined by several key points azimuthal angles and prediction azimuthal angle.
   a. In one example, the axis may be x axis or y axis.
   b. In one example, the key points may be the vertex point, the center point, the middle point of one edge of the rectangle, where the rectangle is the projection of the node onto the x-y plane.
   c. In one example, the number of key points may be two.
      i. In one example, one of the key points may be the center of the rectangle which is the projection of the node onto the x-y plane.
      ii. In one example, one of the key point may be determined by comparing the absolute values of x coordinate and y coordinate.
         1. In one example, at least one of x coordinate value and y coordinate value may be the coordinate value of the center of the rectangle which is the projection of the node onto the x-y plane.
         2. In one example, if the absolute value of x coordinate is less than he absolute value of y coordinate, the key point may be the middle point of edge in x axis negative direction, otherwise, the key point may be the middle point of edge in y axis negative direction, otherwise.
         3. In one example, if the absolute value of x coordinate is less than he absolute value of y coordinate, the key point may be the middle point of edge in y axis negative direction, otherwise, the key point may be the middle point of edge in x axis negative direction, otherwise.
   d. In one example, the context may be determined by the differences between prediction azimuthal angle and key points azimuthal angles.
   e. In one example, azimuthal angle may be replaced by value of the corresponding tangent angle.

### 6. EMBODIMENTS

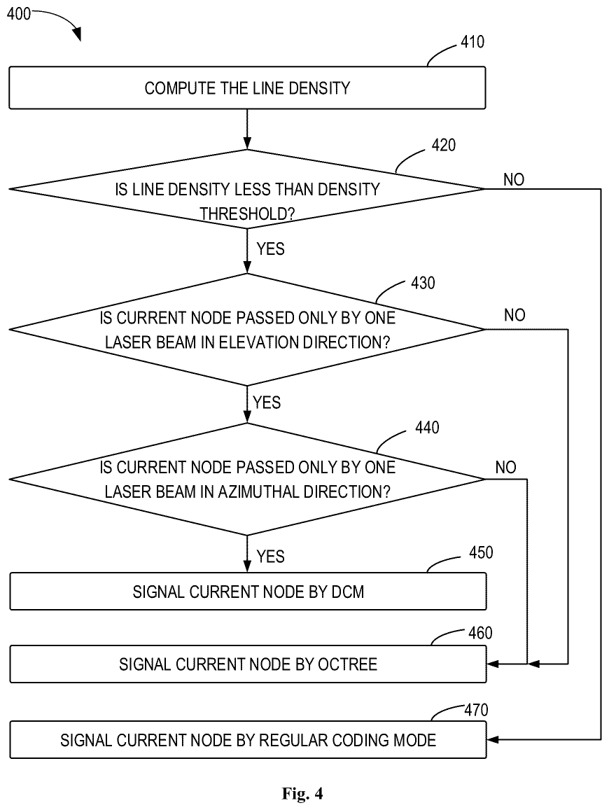

An example of the coding flow 400 for the improvement of point cloud geometry coding using LIDAR characteristics is depicted in FIG. 4. At block 410, the line density is computed. At block 420, whether the line density is less than a density threshold is determined. If it is determined that the line density is greater than or equal to the density threshold at block 420, at block 470, the current node may be signaled by a regular coding mode. If it is determined that the line density is less than the density threshold at block 420, at block 430, whether the current node is passed only by one laser beam in an elevation direction is determined. If it is determined that the current node is not passed only by one laser beam in an elevation direction at block 430, at block 460, the current node may be signaled by octree. If it is determined that the current node is passed only by one laser beam in an elevation direction at block 430, at block 440, whether the current node is passed only by one laser beam in an azimuthal direction is determined. If it is determined that the current node is not passed only by one laser beam in the azimuthal direction at block 440, at block 460, the current node may be signaled by octree. If it is determined that the current node is passed only by one laser beam in the azimuthal direction at block 440, at block 450, the current node may be signaled by DCM.

The embodiments of the present disclosure are related to motion information coding for point cloud coding. As used herein, the term “point cloud sequence” may refer to a sequence of one or more point clouds. The term “frame” may refer to a point cloud in a point cloud sequence. The term “point cloud” may refer to a frame in the point cloud sequence.

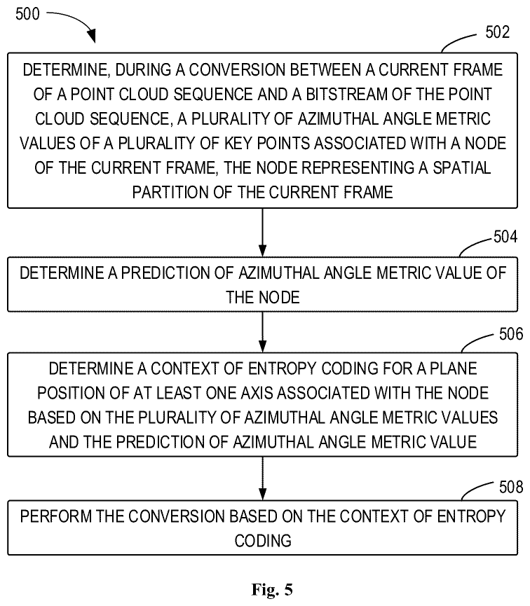

FIG. 5 illustrates a flowchart of method 500 for point cloud coding in accordance with some embodiments of the present disclosure. The method 500 may be implemented during a conversion between a current frame of a point cloud sequence and a bitstream of the point cloud sequence. As shown in FIG. 5, the method 500 starts at block 502, where a plurality of azimuthal angle metric values of a plurality of key points associated with a node of the current frame is determined. The node represents a spatial partition of the current frame.

At block 504, a prediction of azimuthal angle metric value of the node is determined. The prediction may comprise a predicted value of the azimuthal angle or a predicted tangent value of the azimuthal angle. At block 506, a context of entropy coding for a plane position of at least one axis associated with the node is determined based on the plurality of azimuthal angle metric values and the prediction of azimuthal angle metric value. In some example embodiments, the context of entropy coding for the plane position may indicate a position above the plane or below a plane. The plane may be the x-y plane. By determining the context of entropy coding for the plane position based on the plurality of azimuthal angle metric values and the prediction of azimuthal angle metric value, the coding efficiency can be improved.

At block 508, the conversion is performed based on the context of entropy coding. In some embodiments the conversion may include encoding the current frame into the bitstream. Alternatively, or in addition, the conversion may include decoding the current frame from the bitstream.

In some example embodiments, the at least one axis comprises an x axis or y axis. In some example embodiments, the at least one axis may comprise the x axis and the y axis.

In some example embodiments, the azimuthal angle metric value may comprise a value of the azimuthal angle. Alternatively, in some example embodiments, the azimuthal angle metric value may comprise a tangent value of the azimuthal angle. It is to be understood that other metric value such as a cotangent value, a sine value, or a cosine value of the azimuthal angle may also be applied. Scope of the present application is not limited in this regard.

In some example embodiments, the method 500 may further comprise: determining a rectangular projection of the node on a plane associated with the at least one axis. By way of example, the plane associated with the at least one axis may comprise an x-y plane. The method 500 may further comprise determining the plurality of key points based on the rectangular projection.

In some example embodiments, the plurality of key points comprises at least one of the following: a vertex point of the rectangular projection, a center point of the rectangular projection, or a middle point of an edge of the rectangular projection. That is, the key points may be the vertex point, the center point, the middle point of one edge of the rectangle, where the rectangle is the projection of the node onto the x-y plane.

In some example embodiments, a first coordinate value associated with a first axis of the node and a second coordinate value associated with a second axis of the node may be determined. The plurality of key points may be determined by comparing absolute values of the first and second coordinate values.

In some example embodiments, at least one of the first and second coordinate values may be determined based on a coordinate value of a center point of the rectangular projection. In some example embodiments, the first axis comprises an x axis, and the second axis comprises a y axis. By way of example, at least one of x coordinate value and y coordinate value may be the coordinate value of the center of the rectangular projection of the node onto the x-y plane.

In some example embodiments, if a first absolute value of the first coordinate value is less than a second absolute value of the second coordinate value, a middle point of a first edge of the rectangular projection in a negative direction along the first axis may be determined as one of the plurality of key points. Alternatively, or in addition, in some example embodiments, if the first absolute value of the first coordinate value is greater than or equal to the second absolute value of the second coordinate value, a middle point of a second edge of the rectangular projection in a negative direction along the second axis may be determined as one of the plurality of key points.

In some example embodiments, if a first absolute value of the first coordinate value is less than a second absolute value of the second coordinate value, a middle point of a second edge of the rectangular projection in a negative direction along the second axis may be determined as one of the plurality of key points. Alternatively, or in addition, in some example embodiments, if the first absolute value of the first coordinate value is greater than or equal to the second absolute value of the second coordinate value, a middle point of a first edge of the rectangular projection in a negative direction along the first axis may be determined as one of the plurality of key points.

In some example embodiments, the plurality of key points comprises two key points or more than two key points. By way of example, one of the key points may be a center point of a rectangular projection of the node onto the x-y plane. One of the key points may be determined by comparing the absolute values of x coordinate and y coordinate.

In some example embodiments, a plurality of differences between the plurality of azimuthal angle metric values of the plurality of key points and the prediction of azimuthal angle metric value may be determined. At block 506, the context of entropy coding for the plane position may be determined based on the plurality of differences. For example, the context may be determined by the differences between prediction azimuthal angle and key points azimuthal angles.

According to embodiments of the present disclosure, a non-transitory computer-readable recording medium is proposed. A bitstream of a point cloud sequence is stored in the non-transitory computer-readable recording medium. The bitstream of the point cloud sequence is generated by a method performed by a point cloud sequence processing apparatus. According to the method, a plurality of azimuthal angle metric values of a plurality of key points associated with a node of a current frame of the point cloud sequence is determined. The node represents a spatial partition of the current frame. A prediction of azimuthal angle metric value of the node is determined. A context of entropy coding for a plane position of at least one axis associated with the node is determined based on the plurality of azimuthal angle metric values and the prediction of azimuthal angle metric value. The bitstream is generated based on the context of entropy coding.

According to embodiments of the present disclosure, a method for storing a bitstream of a point cloud sequence is proposed. In the method, a plurality of azimuthal angle metric values of a plurality of key points associated with a node of a current frame of the point cloud sequence is determined. The node represents a spatial partition of the current frame. A prediction of azimuthal angle metric value of the node is determined. A context of entropy coding for a plane position of at least one axis associated with the node is determined based on the plurality of azimuthal angle metric values and the prediction of azimuthal angle metric value. The bitstream is generated based on the context of entropy coding. The bitstream is stored in a non-transitory computer-readable recording medium.

Implementations of the present disclosure can be described in view of the following clauses, the features of which can be combined in any reasonable manner.
Clause 1. A method for point cloud coding, comprising: determining, during a conversion between a current frame of a point cloud sequence and a bitstream of the point cloud sequence, a plurality of azimuthal angle metric values of a plurality of key points associated with a node of the current frame, the node representing a spatial partition of the current frame; determining a prediction of azimuthal angle metric value of the node; determining a context of entropy coding for a plane position of at least one axis associated with the node based on the plurality of azimuthal angle metric values and the prediction of azimuthal angle metric value; and performing the conversion based on the context of entropy coding.
Clause 2. The method of clause 1, wherein the at least one axis comprises an x axis or y axis.
Clause 3. The method of clause 1 or clause 2, wherein the plurality of key points comprises two key points.
Clause 4. The method of any of clauses 1-3, further comprising: determining a rectangular projection of the node onto a plane associated with the at least one axis; and determining the plurality of key points based on the rectangular projection.
Clause 5. The method of clause 4, wherein the plane associated with the at least one axis comprises an x-y plane.
Clause 6. The method of clause 4 or clause 5, wherein the plurality of key points comprises at least one of the following: a vertex point of the rectangular projection, a center point of the rectangular projection, or a middle point of an edge of the rectangular projection.
Clause 7. The method of any of clauses 4-6, wherein determining the plurality of key points comprises: determining a first coordinate value associated with a first axis of the node and a second coordinate value associated with a second axis of the node; and determining the plurality of key points by comparing absolute values of the first and second coordinate values.
Clause 8. The method of clause 7, wherein determining the first and second coordinate values comprises: determining at least one of the first and second coordinate values based on a coordinate value of a center point of the rectangular projection.
Clause 9. The method of clause 7 or clause 8, wherein determining the plurality of key points by comparing absolute values of the first and second coordinate value comprises: if a first absolute value of the first coordinate value is less than a second absolute value of the second coordinate value, determining a middle point of a first edge of the rectangular projection in a negative direction along the first axis as one of the plurality of key points; and if the first absolute value of the first coordinate value is greater than or equal to the second absolute value of the second coordinate value, determining a middle point of a second edge of the rectangular projection in a negative direction along the second axis as one of the plurality of key points.
Clause 10. The method of clause 7 or clause 8, wherein determining the plurality of key points by comparing absolute values of the first and second coordinate value comprises: if a first absolute value of the first coordinate value is less than a second absolute value of the second coordinate value, determining a middle point of a second edge of the rectangular projection in a negative direction along the second axis as one of the plurality of key points; and if the first absolute value of the first coordinate value is greater than or equal to the second absolute value of the second coordinate value, determining a middle point of a first edge of the rectangular projection in a negative direction along the first axis as one of the plurality of key points.
Clause 11. The method of any of clauses 7-10, wherein the first axis comprises an x axis, and the second axis comprises a y axis.
Clause 12. The method of any of clauses 1-11, wherein determining the context of entropy coding for the plane position comprises: determining a plurality of differences between the plurality of azimuthal angle metric values of the plurality of key points and the prediction of azimuthal angle metric value; and determining the context of entropy coding for the plane position based on the plurality of differences.
Clause 13. The method of any of clauses 1-12, wherein the azimuthal angle metric value comprises one of the following: a value of the azimuthal angle, or a tangent value of the azimuthal angle.
Clause 14. The method of any of clauses 1-13, wherein the conversion includes encoding the current frame into the bitstream.
Clause 15. The method of any of clauses 1-13, wherein the conversion includes decoding the current frame from the bitstream.
Clause 16. An apparatus for processing point cloud data comprising a processor and a non-transitory memory with instructions thereon, wherein the instructions upon execution by the processor, cause the processor to perform a method in accordance with any of clauses 1-15.
Clause 17. A non-transitory computer-readable storage medium storing instructions that cause a processor to perform a method in accordance with any of clauses 1-15.
Clause 18. A non-transitory computer-readable recording medium storing a bitstream of a point cloud sequence which is generated by a method performed by a point cloud processing apparatus, wherein the method comprises: determining a plurality of azimuthal angle metric values of a plurality of key points associated with a node of a current frame of the point cloud sequence, the node representing a spatial partition of the current frame; determining a prediction of azimuthal angle metric value of the node; determining a context of entropy coding for a plane position of at least one axis associated with the node based on the plurality of azimuthal angle metric values and the prediction of azimuthal angle metric value; and generating the bitstream based on the context of entropy coding.
Clause 19. A method for storing a bitstream of a point cloud sequence, comprising: determining a plurality of azimuthal angle metric values of a plurality of key points associated with a node of a current frame of the point cloud sequence, the node representing a spatial partition of the current frame; determining a prediction of azimuthal angle metric value of the node; determining a context of entropy coding for a plane position of at least one axis associated with the node based on the plurality of azimuthal angle metric values and the prediction of azimuthal angle metric value; generating the bitstream based on the context of entropy coding; and storing the bitstream in a non-transitory computer-readable recording medium.

### Example Device

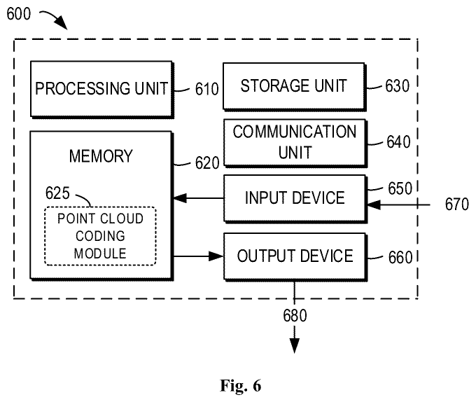

FIG. 6 illustrates a block diagram of a computing device 600 in which various embodiments of the present disclosure can be implemented. The computing device 600 may be implemented as or included in the source device 110 (or the GPCC encoder 116 or 200) or the destination device 120 (or the GPCC decoder 126 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement point cloud encoding/decoding in embodiments of the present disclosure. The memory 620 may include one or more point cloud coding modules 625 having one or more program instructions. These modules are accessible and executable by the processing unit 610 to perform the functionalities of the various embodiments described herein.

In the example embodiments of performing point cloud encoding, the input device 650 may receive point cloud data as an input 670 to be encoded. The point cloud data may be processed, for example, by the point cloud coding module 625, to generate an encoded bitstream. The encoded bitstream may be provided via the output device 660 as an output 680.

In the example embodiments of performing point cloud decoding, the input device 650 may receive an encoded bitstream as the input 670. The encoded bitstream may be processed, for example, by the point cloud coding module 625, to generate decoded point cloud data. The decoded point cloud data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
determining, during a conversion between a current frame of a point cloud sequence and a bitstream of the point cloud sequence, a plurality of azimuthal angle metric values of a plurality of key points associated with a node of the current frame, the node representing a spatial partition of the current frame;
determining a prediction of azimuthal angle metric value of the node;
determining a context of entropy coding for a plane position of at least one axis associated with the node based on the plurality of azimuthal angle metric values and the prediction of azimuthal angle metric value; and
performing the conversion based on the context of entropy coding.

2. The method of claim 1, wherein the at least one axis comprises an x axis or y axis.

3. The method of claim 1, wherein the plurality of key points comprises two key points.

4. The method of claim 1, further comprising:
determining a rectangular projection of the node onto a plane associated with the at least one axis; and
determining the plurality of key points based on the rectangular projection.

5. The method of claim 4, wherein the plane associated with the at least one axis comprises an x-y plane.

6. The method of claim 4, wherein the plurality of key points comprises at least one of the following:
a vertex point of the rectangular projection,
a center point of the rectangular projection, or
a middle point of an edge of the rectangular projection.

7. The method of claim 4, wherein determining the plurality of key points comprises:
determining a first coordinate value associated with a first axis of the node and a second coordinate value associated with a second axis of the node; and
determining the plurality of key points by comparing absolute values of the first and second coordinate values.

8. The method of claim 7, wherein determining the first and second coordinate values comprises:
determining at least one of the first and second coordinate values based on a coordinate value of a center point of the rectangular projection.

9. The method of claim 7, wherein determining the plurality of key points by comparing absolute values of the first and second coordinate value comprises:
if a first absolute value of the first coordinate value is less than a second absolute value of the second coordinate value, determining a middle point of a first edge of the rectangular projection in a negative direction along the first axis as one of the plurality of key points; and
if the first absolute value of the first coordinate value is greater than or equal to the second absolute value of the second coordinate value, determining a middle point of a second edge of the rectangular projection in a negative direction along the second axis as one of the plurality of key points.

10. The method of claim 7, wherein determining the plurality of key points by comparing absolute values of the first and second coordinate value comprises:
if a first absolute value of the first coordinate value is less than a second absolute value of the second coordinate value, determining a middle point of a second edge of the rectangular projection in a negative direction along the second axis as one of the plurality of key points; and
if the first absolute value of the first coordinate value is greater than or equal to the second absolute value of the second coordinate value, determining a middle point of a first edge of the rectangular projection in a negative direction along the first axis as one of the plurality of key points.

11. The method of claim 7, wherein the first axis comprises an x axis, and the second axis comprises a y axis.

12. The method of claim 1, wherein determining the context of entropy coding for the plane position comprises:
determining a plurality of differences between the plurality of azimuthal angle metric values of the plurality of key points and the prediction of azimuthal angle metric value; and
determining the context of entropy coding for the plane position based on the plurality of differences.

13. The method of claim 1, wherein the azimuthal angle metric value comprises one of the following:
a value of the azimuthal angle, or
a tangent value of the azimuthal angle.

14. The method of claim 1, wherein the conversion includes encoding the current frame into the bitstream.

15. The method of claim 1, wherein the conversion includes decoding the current frame from the bitstream.

16. An apparatus for processing point cloud data comprising a processor and a non-transitory memory with instructions thereon, wherein the instructions upon execution by the processor, cause the processor to:
determine, during a conversion between a current frame of a point cloud sequence and a bitstream of the point cloud sequence, a plurality of azimuthal angle metric values of a plurality of key points associated with a node of the current frame, the node representing a spatial partition of the current frame;
determine a prediction of azimuthal angle metric value of the node;
determine a context of entropy coding for a plane position of at least one axis associated with the node based on the plurality of azimuthal angle metric values and the prediction of azimuthal angle metric value; and
perform the conversion based on the context of entropy coding.

17. The apparatus of claim 16, wherein the instructions upon execution by the processor, further cause the processor to:
determine a rectangular projection of the node onto a plane associated with the at least one axis; and
determine the plurality of key points based on the rectangular projection.

18. The apparatus of claim 17, wherein determining the plurality of key points comprises:
determining a first coordinate value associated with a first axis of the node and a second coordinate value associated with a second axis of the node; and
determining the plurality of key points by comparing absolute values of the first and second coordinate values.

19. A non-transitory computer-readable storage medium storing instructions that cause a processor to perform a method comprising:
determining, during a conversion between a current frame of a point cloud sequence and a bitstream of the point cloud sequence, a plurality of azimuthal angle metric values of a plurality of key points associated with a node of the current frame, the node representing a spatial partition of the current frame;
determining a prediction of azimuthal angle metric value of the node;
determining a context of entropy coding for a plane position of at least one axis associated with the node based on the plurality of azimuthal angle metric values and the prediction of azimuthal angle metric value; and
performing the conversion based on the context of entropy coding.

20. A non-transitory computer-readable recording medium storing a bitstream of a point cloud sequence which is generated by a method performed by a point cloud processing apparatus, wherein the method comprises:
determining a plurality of azimuthal angle metric values of a plurality of key points associated with a node of a current frame of the point cloud sequence, the node representing a spatial partition of the current frame;
determining a prediction of azimuthal angle metric value of the node;
determining a context of entropy coding for a plane position of at least one axis associated with the node based on the plurality of azimuthal angle metric values and the prediction of azimuthal angle metric value; and
generating the bitstream based on the context of entropy coding.
